(19) United States
(12) Patent Application Publication
(10) Pub. No.: US 2016/0335807 A1
(43) Pub. Date: Nov. 17, 2016

(54) METHOD AND SYSTEM FOR PROVIDING VIRTUAL FITTING SERVICE

(71) Applicant: TechStyle Fit Ltd., London (GB)

(72) Inventor: Yun Jung LEE, London (GB)

(21) Appl. No.: 14/708,954

(22) Filed: May 11, 2015

(51) Int. Cl. G06T 19/20; G06Q 30/06; G06F 3/0484; G06T 13/40; G06F 3/0481

(52) U.S. Cl. CPC G06T 19/20; G06T 13/40; G06F 3/04815; G06F 3/04842; G06F 3/04845; G06Q 30/0643; G06T 2200/24; G06T 2210/16; G06T 2219/2021; G06T 2219/2012; G06T 2219/2004

(57) ABSTRACT

A system and method for providing a virtual fitting service including a server that receives three-dimensional computer aided design (3D CAD) data from a 3D CAD system via an Internet network and user data from a client terminal via the Internet network. The server generates virtual fitting service data based on the received 3D CAD data and the received user data, wherein the virtual fitting service data include data for fitting a 3D garment generated by the 3D CAD data into a 3D avatar generated by the user data. The client terminal generates a graphical user interface (GUI) of the virtual fitting service by using the received 3D CAD data and the received user data, and provides the generated GUI to a user of the client terminal.

### TECHNICAL FIELD

The disclosure generally relates to a virtual fitting service.

### BACKGROUND

Buying clothes can be a real chore. A person often travels to a store, and then tries on several articles of clothing in a changing room. The person often has to travel to other stores too in order to find desired purchases. Online shopping can be a good alternative to store shopping for both shoppers and retailers, by saving time and effort for shoppers and increasing profit for retailers. However, since shoppers cannot try on the clothes in online shopping, shoppers hesitate to buy clothes online, resulting in a low conversion to purchase. Furthermore, shoppers are 3 times more likely to return an purchase online than an in-store purchase mainly due to fitting issues. Meanwhile, on the designer side of online shopping, it may take weeks to complete a design from conceived concept to a final, manufactured sample. Average 5 to 8 times of sampling for each design costs yearly $6-9 billion in the United States and leads to a long lead time that may include months prior to the designer providing their product to market.

Services have been devised to facilitate online shopping. The devised services may show whether the clothes will fit the shopper and is be provided as a white-labeled software that is embedded on retailers' website. The software uses a graphical user interface (GUI) which enables a shopper to manipulate merchandise displayed by the graphical elements of the GUI. A pointing device such as a mouse, a trackball, a joystick, a pointing stick, a touchpad, or a touchscreen ca be used to manipulate the merchandise. However, online shopping service providers generally require a real product to create digital clothes. It is prohibitively expensive and time consuming for retailers to send physical clothes of each size for each design to a virtual fitting service providers' studio for digitizing the design.

### SUMMARY

In some embodiments, a method for providing a virtual fitting service includes at least: receiving, by a server, a three-dimensional computer aided design (3D CAD) data from a 3D CAD system via an Internet network; receiving, by the server, a user data from a client terminal via the Internet network; generating, by the server, a virtual fitting service data based on the received 3D CAD data and the received user data, wherein the virtual fitting service data includes data for fitting a 3D garment generated by the 3D CAD data on a 3D avatar generated by the user data; generating, by the client terminal, a graphical user interface (GUI) of the virtual fitting service by using the received 3D CAD data and the received user data; and displaying, by the client terminal, the generated GUI to a user of the client terminal.

In some embodiments, a server for providing a virtual fitting service, the server comprising: a communication unit configured to receive, via an Internet network, a three-dimensional computer aided design (3D CAD) data from a 3D CAD system, and receive, via the Internet network, a user data from a client terminal; an application program interface (API) unit configured to provide at least one API for the virtual fitting service; and a control unit configured to generate a virtual fitting service data based on the received 3D CAD data and the received user data, wherein the virtual fitting service data includes data for fitting a 3D garment generated by the 3D CAD data into a 3D avatar generated by the user data, provide, via the Internet network, the virtual fitting service data to the client terminal, and update the virtual fitting service data based on the received user data from the client terminal.

In some embodiments, a system for providing a virtual fitting service, the system comprising: a three-dimensional computer aided design (3D CAD) system configured to generate a 3D CAD data based on a user input into a 3D CAD editor provided by the 3D CAD system; a server connected to the 3D CAD system via an Internet network, and configured to receive, via the Internet network, the 3D CAD data generated by the 3D CAD system, receive, via the Internet network, a user data from a client terminal, and generate virtual fitting service data based on the received 3D CAD data and the received user data, wherein the virtual fitting service data includes data for fitting a 3D garment generated by the 3D CAD data into a 3D avatar generated by the user data, provide, via the Internet network, the generated GUI to the client terminal, receive, via the Internet network, user data from the client terminal, and update the GUI of the virtual fitting service based on the received user data; and the client terminal connected with the server via an Internet network, and configured to generate a graphical user interface (GUI) of the virtual fitting service by using the virtual fitting service data received from the server.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of a system for implementing a virtual fitting service in accordance with one or more embodiments.

FIG. 2 is a flow diagram of an embodiment of a process for providing the virtual fitting service in accordance with one or more embodiments.

FIGS. 3 and 4 are schematics illustrating a user interface in accordance with one or more embodiments in accordance with one or more embodiments.

FIG. 5 is schematic of a user interface for providing the virtual fitting service in accordance with one or more embodiments.

FIG. 6 is a flow diagram of an embodiment of a process for providing the virtual fitting service in accordance with one or more embodiments.

FIG. 7 is a block diagram illustrating an embodiment of a server configured to provide the virtual fitting service in accordance with one or more embodiments.

### All arranged in accordance with at least some embodiments of the present disclosure.

### DETAILED DESCRIPTION

The following disclosure provides many different embodiments, or examples, for implementing different features of the disclosed subject matter. Specific examples of components and arrangements are described below to simplify the present disclosure. These are examples and are not intended to be limiting.

In the following detailed description, reference is made to the accompanying figures, which form a part hereof. In the figures, similar symbols typically identify similar components, unless the context dictates otherwise. The illustrative embodiments described in the detailed description, figures, and claims are not meant to be limiting. Other embodiments are also utilized, and other changes are also made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

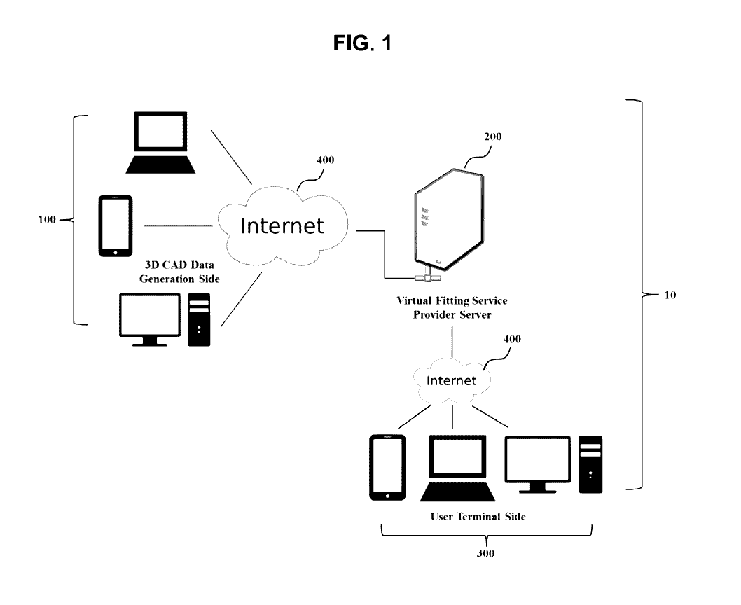

FIG. 1 is a block diagram of a system for implementing a virtual fitting service in accordance with one or more embodiments.

In an example embodiment, a system 10 includes a 3D CAD Data generation side, a virtual fitting service provider server 200 and a client side. One or more three-dimensional computer aided design (3D CAD) systems 100 are included the 3D CAD Data generation side, and one or more client terminals 300 are included in the client side. Further, one or more clothing manufacturing side server (not shown) are disposed on a side of the 3D CAD systems 100. The system 10 is configured to provide a virtual fitting service. The 3D CAD system 100, the virtual fitting service provider server 200, the client terminal 300, and the manufacturing side server (not shown) are connected each other via an Internet. The 3D CAD system 100 and the virtual fitting service provider server 200 are separated and placed in different locations. In some embodiments, the 3D CAD system 100 is located in a 3D CAD designer's workplace and managed by the 3D CAD designer, and the virtual fitting service provider server 200 is located in a service provider's workplace and managed by the service provider. The 3D CAD system 100 is configured to transmit the 3D CAD data in a complete version. In some embodiments, “a complete version 3D CAD data” does not need to be further edited by a 3D CAD program. Thus, the virtual fitting service provider server 200 does not further edit the 3D CAD data. In some embodiments, no digitization process is necessary for physical clothes as 3D digital clothes are created before physical clothes are made. The virtual fitting service provider server 200 provides a virtual fitting service by using the 3D CAD data received from the 3D CAD system 100. That is, a 3D CAD for fashion design is interrelated with a virtual fitting service provider for integrating virtual fitting system. This integrated system of 3D CAD and virtual fitting not only enables designers to design quickly, but also remove the need for the process of turning physical clothes into digital clothes for virtual fitting. Once a designer finishes a design in 3D CAD, the outcome, 3D digital clothes are uploaded the brands' website for virtual fitting system without any further digitalization process.

In some embodiments, the virtual fitting service is a web-based service. This web-based virtual fitting system provides an efficient environment to vertically integrated apparel brands who design, manufacture, and retail online. For example, brands can test a design's popularity before mass manufacturing by uploading digital clothes created by 3D CAD in virtual fitting system. Depending on how the design is received by shoppers, brands can decide how much to produce or not to produce at all.

In some embodiments, the 3D CAD system 100 provides the 3D CAD editor for a user, and generates a 3D CAD data based on a user input. The 3D CAD editor runs on the 3D CAD system. The user of the 3D CAD editor includes designers of fashion brands.

In some embodiments, the virtual fitting service provider server 200 is connected with the 3D CAD system 100 via an Internet, and receives via the Internet network, the 3D CAD data generated by the 3D CAD system 100. That is, the virtual fitting service provider server 200 does not need to store or provide the 3D CAD editor since the virtual fitting service provider server 200 receives a complete version 3D CAD data from the 3D CAD system 100. Instead, the virtual fitting service provider server 200 stores and provides a 3D CAD reader to provide the virtual fitting service. In some embodiments, the 3D CAD system 100 communicates with the virtual fitting service provider server 200 by using a different network than the Internet. For example, the data are transmitted via at least one of a cellular network, a Wi-Fi network and a satellite network. In some embodiments, the data are transmitted via a transmitter. In some embodiments, the 3D CAD system 100 directly sends the data to the virtual fitting service provider server 200.

The virtual fitting service provider server 200 generates virtual fitting service data based on received 3D CAD data and received user data. The virtual fitting service data includes data for fitting a 3D garment generated by the 3D CAD data in a 3D avatar generated by the user data.

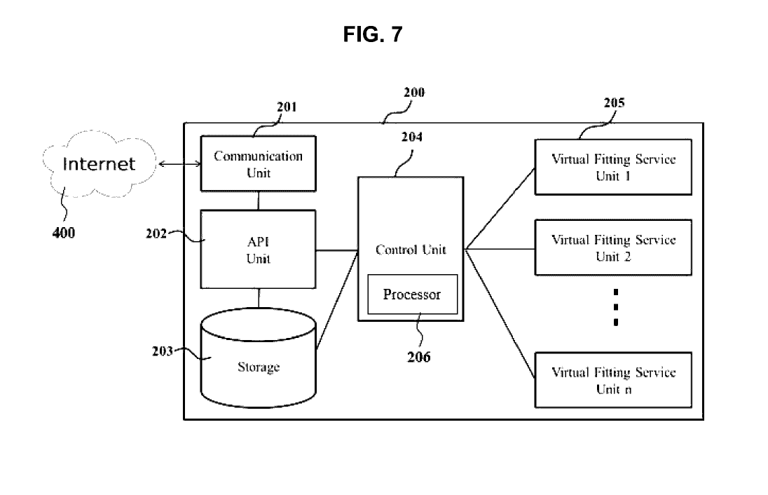

In some embodiments, the virtual fitting service provider server 200 reads the received 3D CAD data by using a stored 3D CAD reader and generates the virtual fitting service data by using a API unit (e.g., API unit 202 shown in FIG. 7) and a control unit (e.g., control unit 204 shown in FIG. 7). In some embodiments, the virtual fitting service is a web-based service.

In some embodiments, the virtual fitting service provider server 200 generates a 3D garment based on at least one information selected from the group consisting of size information, material information and color information, by using the received 3D CAD data. The virtual fitting service provider server 200 generates a 3D avatar based on stored user data, and puts the generated 3D garment on the generated 3D avatar.

The virtual fitting service provider server 200 provides, via the Internet network, the generated virtual fitting service data to a client terminal. In some embodiments, the client terminal includes: a display unit configured to display a graphical user interface (GUI) of the virtual fitting service, and a processor that controls the display unit and other elements of the client terminal. A ‘client terminal’ includes a smart phone as well as a general desktop computer, and a digital device including a memory unit and a processor having calculation capability, such as, a mobile communication terminal, a desktop computer, a laptop computer, a workstation, a palmtop computer, a personal digital assistant (PDA), a web pad, or the like. The virtual fitting service provider server 200 receives, via the Internet network 400, user data from the client terminal 300, and updates the virtual fitting service data based on the received user data. In some embodiments, the user data includes a body measurement of a user, a user preference, and a user selection. For example, the virtual fitting service provider server 200 updates the virtual fitting service data of the 3D avatar to correspond to the body measurement included in the user data. The display unit, in some embodiments, includes a light-emitting display, such as a backlit LCD, light-emitting diode (LED) display, or organic LED (OLED) display.

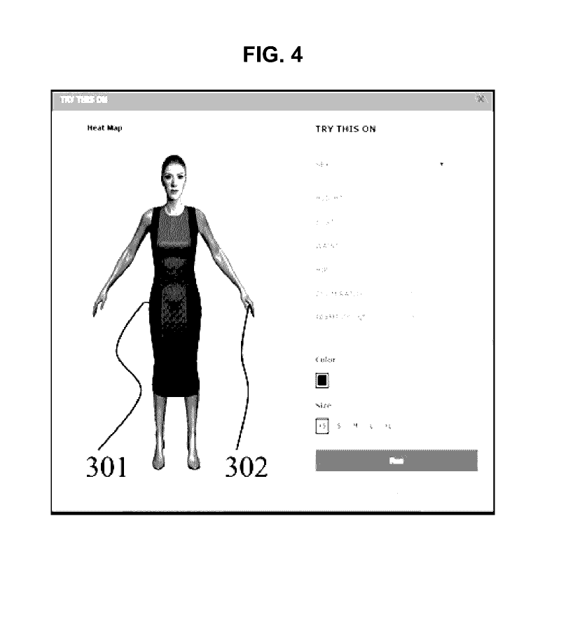

In some embodiments, the virtual fitting service provider server 200 synchronizes a 3D garment (e.g., 3D garment 301 shown in FIG. 3) with a 3D avatar (e.g., 3D avatar 302 shown in FIG. 3) of the virtual fitting service based on the user data. Thus, the fitting accuracy 3D garments with the 3D avatar are enhanced. According to the 3D avatar and the 3D garments to be provided, the user can use the virtual fitting service in real time. Furthermore, sizes and choice of color are also simulated in real time. Meanwhile, in some embodiments, based on an Internet connection, the 3D CAD data edited in the 3D CAD system 100 is transmitted to the virtual fitting service provider server 200 in real time so that the virtual fitting service provider server 200 promptly updates its virtual fitting service in response to the edited 3D CAD data. Thus, a user of the client terminal immediately watches and uses the virtual fitting service which is promptly updated in response to a designer's editing.

In some embodiments, the virtual fitting service provider server 200 positions the generated 3D garment on the generated 3D avatar, and receives body measurement data from the client terminal. In some embodiments, based on the received body measurement, the virtual fitting service provider server 200 updates a shape of the 3D avatar. In some embodiments, the virtual fitting service provider server 200 adjusts a position and an orientation of the 3D garment on the updated 3D avatar by tracking the differences between the generated avatar's bones and those of the updated 3D avatar.

The client terminal 300 is connected to the server via an Internet network, receives, via the Internet network, the virtual fitting service data generated by the server. The client terminal 300 generates a graphical user interface (GUI) of the virtual fitting service by using the received virtual fitting service data and displays a virtual fitting screen based on the generated GUI. An embodiment of the GUI of the virtual fitting service is shown in FIG. 4 below. The client terminal 300 decodes the received virtual fitting service data, and converts the decoded virtual fitting service data to be a format used for generating the GUI of the client terminal 300. The client terminal 300 collects user data based on user inputs or measurements data generated by capturing and analyzing user images, and transmits the user data to the server. The client terminal 300 collects user data by using a user input or by detecting user information. In some embodiments, when the user inputs the user's body measurement, such as a height and a weight, the client terminal 300 generates the user data to include the inputted body measurement. In some embodiments, the client terminal 300 captures the body of the user by a camera module, analyzes the captured body, and extracts body measurements from analysis data. In some embodiments, the extracted body measurement is included in the user data.

In some embodiments, the virtual fitting service provider server 200 models a plurality of exemplary 3D avatars based on stored body shape data. When an updated body measurement data from the client terminal is received, the virtual fitting service provider server 200 selects one 3D avatar among the plurality of exemplary 3D avatars based on the body measurement data of the user, and adjusts a shape of the selected 3D avatar based on the body measurement data of the user.

In some embodiments, the virtual fitting service provider server 200 receives order information from the client terminal. ISE, the order information includes information on a size selection, a color selection, and a number section, of garments. The virtual fitting service provider server 200 stores the received order information, and transmits the stored order information to a manufacturer device (not shown) so that a manufacturer manufactures garments based on user demands.

In some embodiments, a user of the 3D CAD system 100 is a designer of the fashion brand, and a user of the client terminal 300 is a shopper or a retailer who uses the virtual fitting service provided by the virtual fitting service provider server 200.

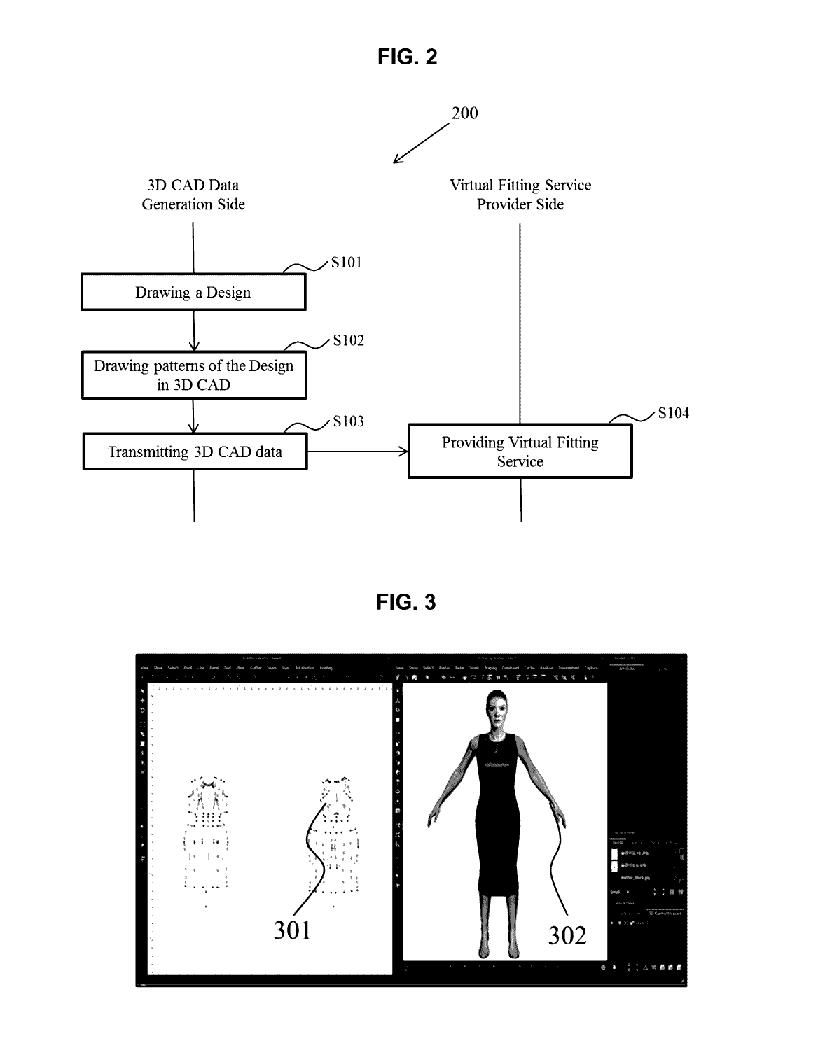

FIG. 2 is a flow diagram of an embodiment of a process for providing the virtual fitting service in accordance with one or more embodiments.

In some embodiments, a 3D CAD data generating side, including one or more 3D CAD systems 100 and a virtual fitting service provider side, including one or more virtual fitting service provider servers 200 perform steps for providing a virtual fitting service.

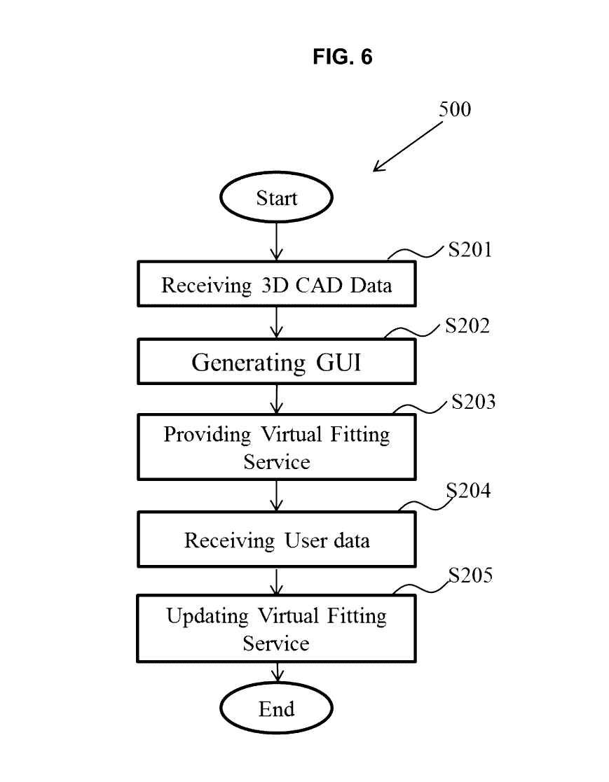

Method 200 begins with, at step 101, a user of the 3D CAD system 100 draws a design for a garment. At step 102, the 3D CAD system 100 draws patterns of the design in 3D CAD data. At step 103, the 3D CAD system 100 transmits the 3D CAD data to the virtual fitting service provider side. In some embodiments, the 3D CAD data includes a complete version 3D CAD data for providing 3D garments in the virtual fitting service. Even before physical garments are created, the 3D garment is able to be directly uploaded to an Internet for transmitting it to the virtual fitting service provider side for providing a virtual fitting on a web environment. Thus, neither further digitization nor further editing by using a 3D CAD editor is necessary at the virtual fitting service provider side. Thus, the virtual fitting service provider side does not need to provide 3D garment editing tools. At S104, the virtual fitting service provider side provides the virtual fitting services, as described above. According to these steps, to users of the virtual fitting service, it is not necessary to deal with bulky materials such as paper and textiles to draw/cut patterns on, and not necessary to sew a real garment. A detailed description for providing the virtual fitting service is disclosed in FIG. 6 and corresponding descriptions.

FIGS. 3 and 4 are schematics illustrating a user interface in accordance with one or more embodiments in accordance with one or more embodiments.

Referring to FIG. 3, a user of the 3D CAD system 100 designs 3D CAD data of a garment by using an interface shown in FIG. 3, and if a virtual fitting service provider server 200 receives the 3D CAD garment data from the 3D CAD system 100, the virtual fitting service provider server 200 generates virtual fitting service data and provides the generated data to a client terminal 300. The client terminal 300 generates a graphical user interface (GUI) of the virtual fitting service as shown in FIG. 4. In some embodiments, the client terminal 300 generates the GUI based on a complete version 3D CAD data which was utilized for generating the virtual fitting service data. That is, for providing the GUI as FIG. 4, the virtual fitting service provider server 200 does not further edit the received 3D CAD data. In some embodiments, as shown in FIG. 4, the interface includes at least one of a zoom in menu, a zoom out menu, an avatar rotating menu, a gender input menu, a height size input menu, a bust size input menu, a waist size input menu, and a hip size input menu. Thus, the interface is getting users feeling a fit and style of garments, by using the online virtual fitting service.

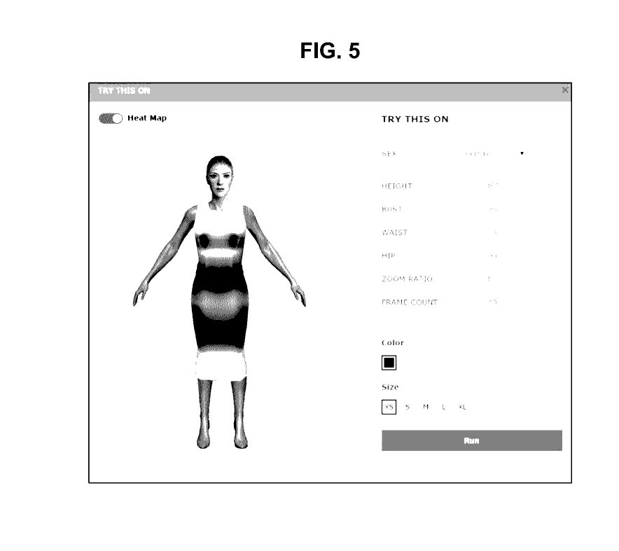

FIG. 5 is schematic of a user interface for providing the virtual fitting service in accordance with one or more embodiments.

Referring to FIG. 5, the client terminal 300 generates a strain map with the graphical user interface (GUI) of FIG. 4, for the virtual fitting service as shown in FIG. 5. In some embodiments, the client terminal 300 generates the strain map with the GUI based on a complete version 3D CAD data which was utilized for generating the virtual fitting service data. The strain map is produced based on mapping data associated with the 3D CAD data and the 3D avatar. For example, when a portion of the 3D garment is within a predetermined distance to a corresponding portion of the 3D avatar, that corresponding portion's color is shown in a brighter color than that of the other portion of the 3D garment, which is outside of the predetermined distance to the corresponding portion of the 3D avatar. Thus, users check the 3D garment in detail by checking which portion of the 3D garment more accurately fits their body, or by checking which portion of the 3D garment is twisted from an original design.

FIG. 6 is a flow diagram of an embodiment of a process for providing the virtual fitting service in accordance with one or more embodiments.

In some embodiments, a virtual fitting service provider server 200 performs steps shown in FIG. 6 for providing a virtual fitting service.

Method 500 begins, at step S201, the server 200 receives, via an Internet network, 3D CAD data from a 3D CAD system 100. At step S202, the server 200 receives, via the Internet network, user data from a client terminal 300. In some embodiments, server 200 is equipped with a communication unit compatible with different telecommunication standards including WLAN (Wireless LAN) (Wi-Fi), Wibro (Wireless broadband), Wi-max (World Interoperability for Microwave Access), HSDPA (High Speed Downlink Packet Access), and so on. In some embodiments, the server 200 includes a 3D CAD reader for reading the received 3D CAD data. and in some embodiments, the server 200 does not include a 3D CAD editor for generating another 3D CAD data.

At step S203, the server 200 generates virtual fitting service data by using the received 3D CAD data. In some embodiments, 3D garment is generated based on at least one information selected from the group consisting of size information, material information and color information, by using the received 3D CAD data. In some embodiments, 3D avatar is generated based on stored user data. In some embodiments, the generated 3D garment is put on the generated 3D avatar. These 3D garments and 3D avatar are included in the virtual fitting service data.

In some embodiments, the generated 3D garment is positioned on the generated 3D avatar. If body measurement data is received from the client terminal, a shape of the 3D avatar is updated based on the received body measurement so that a position and an orientation of the 3D garment are adjusted on the updated 3D avatar by tracking the differences between the generated avatar's frames and those of the updated 3D avatar. Thus, for the GUI of the virtual fitting service, the 3D garment with the 3D avatar are synchronized based on the user data.

In some embodiments, the server 200 is configured to model a plurality of exemplary 3D avatars based on stored body shape data, receive an updated body measurement data from the client terminal, select one 3D avatar among the plurality of exemplary 3D avatars based on the body measurement data, and adjust a shape of the selected 3D avatar based on the body measurement data.

At step S204, the server 200 provides, via the Internet network, the generated virtual fitting service data to the client terminal 300. At step S205, the server 200 updates the virtual fitting service data based on the user data received from the client terminal 300.

In some embodiments, the server 200 receives order information from the client terminal, and stores the received order information. The server transmits the stored order information to a clothing manufacturer's device (not shown in FIG. 1) for manufacturing garments.

In some embodiments, the server 200 provides the virtual fitting service data for providing a digital evaluation, instead of a physical evaluation that entails making samples of the whole collection and bringing the whole collection into overseas' buyers, for users, regarding 3D garments. For example, a 3D digital fashion show is displayed on the client terminal's screen by controlling the server 200.

FIG. 7 is a block diagram illustrating an embodiment of a server configured to provide the virtual fitting service in accordance with one or more embodiments.

FIG. 7 is a block diagram illustrating an example server for providing the virtual fitting service.

A virtual fitting service provider server 200 includes a communication unit 201, an application program interface (API) unit 202, a storage medium 203, a control unit 204, one or more virtual fitting service units 205, and a processor 206.

The communication unit 201 receives, via an Internet network, 3D CAD data from a 3D CAD system 100, and receives, via the Internet network user data from a client terminal.

In some embodiments, the communication unit 201 is capable of performing a close range wireless (or radio) communication with other electronic devices. In some embodiments, communication unit 201 is compatible with various telecommunication standards, including Bluetooth, RFID (Radio Frequency Identification), IrDA (Infrared Data Association), UWB (Ultra Wideband), ZigBee, DLNA (Digital Living Network Alliance). An external image display device, such as a backlit LCD, light-emitting diode (LED) display, or organic LED (OLED) display, is able to be connected to other electronic devices via network for displaying the virtual fitting service.

In some embodiments, the communication unit 201 provides an interface for connecting the virtual fitting service provider server 200 to a wired/wireless network including an internet network. In some embodiments, the communication unit 201 is provided with an Ethernet terminal. In some embodiments, in a wireless network, the communication unit 201 is compatible with different telecommunication standards including WLAN (Wireless LAN) (Wi-Fi), Wibro (Wireless broadband), Wimax (World Interoperability for Microwave Access), HSDPA (High Speed Downlink Packet Access).

In some embodiments, the communication unit 201 is connected to a particular webpage (web-based virtual fitting service) via the network. More specifically, the network interface unit may access a particular webpage through a network connection, thereby being capable of transmitting or receiving data to or from a client terminal.

The API unit 202 provides at least one API for the virtual fitting service. In some embodiments, data for the API is stored in the storage medium 203. The control unit 204 generates virtual fitting service data by using 3D CAD data received from the 3D CAD system 100 and user data received from the client terminal. In some embodiments, the control unit 204 loads a virtual fitting platform from the storage medium 203, extracts 3D garment data from the received 3D CAD data, and applies the extracted 3D garment data into the loaded virtual fitting platform for generating the virtual fitting service data.

In some embodiments, the control unit 204 generates the 3D garment based on at least one information selected from the group consisting of size information, material information and color information, by using the received 3D CAD data. The control unit 204 also generates a 3D avatar based on stored or received user data, and puts the generated 3D garment on the generated 3D avatar.

The control unit 204 provides the generated virtual fitting service data to one or more client terminals, receives user data from the client terminals, and updates the virtual fitting service data based on the received user data. The control unit 204 controls the overall operations within the virtual fitting service provider server 200. In some embodiments, the control unit 204 uses one or more virtual fitting service unit 205 for providing the virtual fitting service to one or more client terminal. In some embodiments, the number of the virtual fitting service units corresponds to the number of the client terminals which uses the virtual fitting service. For example, the server 200 includes three (3) virtual fitting service units for providing the virtual fitting service to three (3) client terminals.

In some embodiments, the control unit 204 distributes requests received from user terminals to one or more virtual fitting service units 205 when the control unit 204 receives the requests more than a predetermined amount. The requests include input data regarding a virtual fitting service. That is, the control unit 204 handles a data traffic by distributing the requests to the one or more virtual fitting service units 205. Then, one or more virtual fitting service units 205 generate virtual fitting service data based on the distributed requests.

In some embodiments, the control unit 204 synchronizes the 3D garment with the 3D avatar based on the user data. In another embodiments, the control unit 204 positions the generated 3D garment on the generated 3D avatar. Further, the control unit 204 receives, via the communication unit 201, body measurement data from the client terminal, and updates a shape of the 3D avatar based on the received body measurement so that adjusting a position and an orientation of the 3D garment on the updated 3D avatar by tracking the differences between the generated avatar's bones and those of the updated 3D avatar.

In some embodiments, the control unit 204 models a plurality of exemplary 3D avatars referring to stored body shape data. Further, the control unit 204 receives, via the communication unit 201, receives body measurement data from the client terminal. The control unit 204 selects one 3D avatar among the plurality of exemplary 3D avatars based on the body measurement data, and adjusts a shape of the selected 3D avatar based on the body measurement data.

In some embodiments, the control unit 204 models a plurality of exemplary 3D avatars referring to user face data. For example, the control unit 204 extracts a picture of a users' face from stored pictures in the storage 203, then the control unit 204 generate 3D face data based on the extracted picture. The control unit combines user's 3D face generated based on the generated 3D face data with generated 3D body, for providing user-friendly 3D avatar. In some embodiments, the control unit 204 receives one or more images of user faces from one or more user terminal.

Further, the control unit 204 receives, via the communication unit 201, received body measurement data from the client terminal. The control unit 204 selects one 3D avatar among the plurality of exemplary 3D avatars based on the body measurement data, and adjusts a shape of the selected 3D avatar based on the body measurement data.

In some embodiments, processor 206 is configured to execute the method described in FIG. 2 and/or FIG. 6. The processor 206 executes instructions stored in the storage medium 203.

The various distinctive characteristics and technological ideas, described above, can be realized as being in the form of software, hardware, firmware, middleware or a combination of them. In some embodiments, a program for realizing a method of providing the virtual fitting service, which is stored in a computer-readable medium (which is executed by a computer or a controller including a CPU), includes one or more program codes and sections that perform various tasks.

The storage 203 stores data for providing the virtual fitting service. In some embodiments, the storage 203 stores a 3D CAD reader for reading the received 3D CAD data. In some embodiments, the storage 203 does not store a 3D CAD editor for generating another 3D CAD data.

In some embodiments, the storage 203 includes magnetic disks, optical disks, or tape. The storage 203 includes volatile and nonvolatile, removable and non-removable media implemented in any method or technology for storage of information, such as computer readable instructions, data structures, program modules, or other data. The storage 203 includes, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which is used to store information and which is accessed by control unit 203. In some embodiments, the virtual fitting service provider server 200 further includes input device(s) such as a keyboard, a mouse, a pen, a sound input device, a touch input device, etc., and output device(s) such as a display, speakers, a printer, etc. is also included. The aforementioned devices are examples.

Each of the above identified instructions and applications can correspond to a set of instructions for performing one or more functions described above. These instructions need not be implemented as separate software programs, procedures, or modules. The storage 203 can include additional instructions or fewer instructions. Furthermore, various functions of the virtual fitting service provider server 200 can be implemented in hardware and/or in software, including in one or more signal processing and/or application specific integrated circuits.

It will be readily seen by one of ordinary skill in the art that the disclosed embodiments fulfill one or more of the advantages set forth above. The configuration and the method of the embodiments according to the present disclosure, described above, are not applied in a limiting manner, but all of or some of the embodiments may be selectively combined with each other to create various modifications to the embodiments.

It will also be apparent to those skilled in the art that various modifications and variations can be made in the present disclosure without departing from the spirit or scope of the disclosure. Thus, it is intended that the present disclosure cover modifications and variations of this disclosure provided they come within the scope of the appended claims and their equivalents.

What is claimed is:

1. A method for providing a virtual fitting service by a virtual fitting system, the method comprising:
receiving, by a server, a three-dimensional computer aided design (3D CAD) data from a 3D CAD system via an Internet network;
receiving, by the server, a user data from a client terminal via the Internet network;
generating, by the server, a virtual fitting service data based on the received 3D CAD data and the received user data, wherein the virtual fitting service data includes data for fitting a 3D garment generated by the 3D CAD data on a 3D avatar generated by the user data;
generating, by the client terminal, a graphical user interface (GUI) of the virtual fitting service by using the received 3D CAD data and the received user data; and
displaying, by the client terminal, the generated GUI to a user of the client terminal.

2. The method of claim 1, wherein the server includes a 3D CAD reader configured to read the received 3D CAD data and does not include a 3D CAD editor for generating another 3D CAD data.

3. The method of claim 1, wherein the generating the virtual fitting service data comprises:
positioning the 3D garment on the 3D avatar;
receiving a body measurement data from the client terminal;
updating a shape of the 3D avatar based on the received body measurement data;
adjusting a position and an orientation of the 3D garment on the updated 3D avatar by tracking the differences between the generated avatar's frames and those of the updated 3D avatar.

4. The method of claim 1, further comprising:
updating, by the client terminal, the GUI of the virtual fitting service based on a user input.

5. The method of claim 1, further comprising:
synchronizing the 3D garment with the 3D avatar based on the received user data.

6. The method of claim 1, further comprising:
receiving order information from the client terminal;
storing the received order information; and
transmitting the stored order information to a clothing manufacturers device.

7. The method of claim 1, wherein the generating the virtual fitting service data comprises:
modelling a plurality of exemplary 3D avatars based on a stored body shape data;
receiving an updated body measurement data from the client terminal;
selecting one 3D avatar from the plurality of exemplary 3D avatars based on the body measurement data; and
adjusting a shape of the selected 3D avatar of the plurality of exemplary 3D avatars based on the body measurement data.

8. A server configured to provide a virtual fitting service, the server comprising:
a communication unit configured to
receive, via an Internet network, a three-dimensional computer aided design (3D CAD) data from a 3D CAD system, and
receive, via the Internet network, a user data from a client terminal;
an application program interface (API) unit configured to provide at least one API for the virtual fitting service; and
a control unit configured to
generate a virtual fitting service data based on the received 3D CAD data and the received user data, wherein the virtual fitting service data includes data for fitting a 3D garment generated by the 3D CAD data into a 3D avatar generated by the user data,
provide, via the Internet network, the virtual fitting service data to the client terminal, and
update the virtual fitting service data based on the received user data from the client terminal.

9. The server of claim 8, wherein the server stores a 3D CAD reader configured to read the received 3D CAD data and does not store a 3D CAD editor for generating another 3D CAD data.

10. The server of claim 8, wherein the server is further configured to
generate the 3D garment based on at least one information selected from the group consisting of size information, material information and color information, by using the received 3D CAD data,
generate the 3D avatar based on stored user data, and
dress the generated 3D garment on the generated 3D avatar.

11. The server of claim 8, wherein the server is further configured to
position the generated 3D garment on the generated 3D avatar,
receive a body measurement data from the client terminal,
update a shape of the 3D avatar based on the received body measurement data, and
adjust a position and an orientation of the 3D garment on the updated 3D avatar by tracking the differences between the generated avatar's frames and those of the updated 3D avatar.

12. The server of claim 8, wherein the server is further configured to synchronize the 3D garment with the 3D avatar based on the received user data.

13. The server of claim 8, wherein the server is further configured to
model a plurality of exemplary 3D avatars referring to stored body shape data;
receive body measurement data from the client terminal;
select one 3D avatar among the plurality of exemplary 3D avatars based on the body measurement data; and
adjust a shape of the selected 3D avatar based on the body measurement data.

14. A system for providing a virtual fitting service, the system comprising:
a three-dimensional computer aided design (3D CAD) system configured to generate a 3D CAD data based on a user input into a 3D CAD editor provided by the 3D CAD system;
a server connected to the 3D CAD system via an Internet network, and configured to
receive, via the Internet network, the 3D CAD data generated by the 3D CAD system,
receive, via the Internet network, a user data from a client terminal, and
generate virtual fitting service data based on the received 3D CAD data and the received user data, wherein the virtual fitting service data includes data for fitting a 3D garment generated by the 3D CAD data into a 3D avatar generated by the user data,
provide, via the Internet network, the generated GUI to the client terminal,
receive, via the Internet network, user data from the client terminal, and
update the GUI of the virtual fitting service based on the received user data; and
the client terminal connected with the server via an Internet network, and configured to generate a graphical user interface (GUI) of the virtual fitting service by using the virtual fitting service data received from the server.

15. The system of claim 14, wherein the server stores a 3D CAD reader configured to read the received 3D CAD data and does not store a 3D CAD editor for generating another 3D CAD data.

16. The system of claim 14, wherein the server is further configured to
generate the 3D garment based on at least one information selected from the group consisting of size information, material information and color information, by using the received 3D CAD data,
generate the 3D avatar based on stored user data, and
dress the generated 3D garment on the generated 3D avatar.

17. The system of claim 14, wherein the server is further configured to
position the generated 3D garment on the generated 3D avatar,
receive a body measurement data from the client terminal,
update a shape of the 3D avatar based on the received body measurement data, and
adjust a position and an orientation of the 3D garment on the updated 3D avatar by tracking the differences between the generated avatar's frames and those of the updated 3D avatar.

18. The system of claim 14, wherein the server is further configured to synchronize the 3D garment with the 3D avatar based on the received user data.

19. The system of claim 14, wherein the server is further configured to
model a plurality of exemplary 3D avatars based on a stored body shape data,
receive an updated body measurement data from the client terminal,
select one 3D avatar from the plurality of exemplary 3D avatars based on the received body measurement data, and
adjust a shape of the selected 3D avatar of the plurality of exemplary 3D avatars based on the received body measurement data.

20. The system of claim 14, wherein the server is further configured to
receive an order information from the client terminal,
store the received order information, and
transmit the stored order information to a clothing manufacturers device.
